(19) United States
(12) Patent Application Publication
(10) Pub. No.: US 2022/0098878 A1
(43) Pub. Date: Mar. 31, 2022

(54) LOAD BEARING RAISED FLOORING SYSTEM PANEL WITH INTEGRATED LOAD EXCESS INDICATOR

(71) Applicant: International Business Machines Corporation, Armonk, NY (US)

(72) Inventors: Colin Ian Holyoake, Braishfield (GB); Maurice Francis Gray, Whitchurch (GB); Graham Jon Eames, Winchester (GB); Michael James Bettle-Shaffer, Hampshire (GB)

(21) Appl. No.: 17/038,733

(22) Filed: Sep. 30, 2020

(51) Int. Cl. E04F 15/024; E04F 15/10; H05B 47/115

(52) U.S. Cl. CPC E04F 15/02405; H05B 47/115; E04F 15/107

(57) ABSTRACT

A load bearing raised flooring system panel, having an integrated pressure sensitive layer adapted to generate a visual indication when excess load is applied to the load bearing raised flooring system panel. The pressure sensitive layer determines how much pressure (or load) is applied to the load bearing raised flooring system panel, and upon detecting pressure above a threshold, indicative of excess load, a visual indication is generated and displayed on the load bearing raised flooring system panel.

### BACKGROUND

The present invention relates to raised floor panels, and particularly to raised floor panels that have improved visual mechanisms for indicating excess load or pressure on a raised floor system.

A raised floor is a floor elevated above a solid base, such that it creates a hidden void that allows electrical cables and other infrastructure equipment to be accommodated underneath the raised floor. They are widely used in office buildings and data centers, as they allow the passage of data and other essential cables, water supply pipes and air conditioning systems to be routed in a space efficient manner.

A conventional raised floor system is comprised of floor panels, which create the flat surface and a plurality of pedestals that support the floor panels above the solid base. The plurality of pedestals are joined together using stringer bars, which creates a framework of floor panels and provides lateral integrity to the raised floor system. Conventional floor panels are 600 mm×600 mm and are formed of steel-encased particleboard. The specification of the floor panel is chosen depending on the function of the raised floor. Some floor panels are perforated to control the airflow in a room, and some floor panels are covered with a variety of flooring finished to suit the application, such as carpet, marble and antistatic finishes.

Raised floors are tested and rated for their pressure capacity. The pressure capacity rating indicates the maximum pressure a floor panel can take before it starts to get damaged. Equipment and floor damage can occur if the load on the raised floor exceeds the pressure capacity. This problem can arise if the installation of the floor was flawed or the specifications of the floor panels were not chosen correctly.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later.

Conventional floor panels do not give any indication of a potential or an existing load issue until damage begins to occur. The current method to mitigate the failure of a raised floor is to have regular, manual inspections for the structural integrity of the raised floor system. This is costly and time-consuming.

The present invention describes a pressure sensitive load bearing raised flooring system panel to allow a visual indication of the load that is placed on a raised floor system. The pressure sensitive load bearing raised flooring system panel comprises a first surface, a pressure sensitive layer and may have additional layers disposed underneath the layer for further functions. The first surface may be comprised of a material to protect the rest of the flooring panel, and it may have portions of the pressure sensitive layer embedded in it.

The pressure sensitive layer comprises a pressure sensitive material which may intrinsically change its visual characteristics upon excess load pressure, or it may comprise a pressure sensitive material which is capable of producing an electric signal that is sent to a visual component, which is operable for visually indicating the excess load pressure. The generation of a visual overloading warning will allow users to visually identify issues with the raised floor system.

Viewed from a first aspect, the present invention provides a load bearing raised flooring system panel, comprising a pressure sensitive layer adapted to generate a visual indication at a first surface of the load bearing raised flooring system panel in response to a loading of the load bearing raised flooring system panel exceeding a preset pressure capacity threshold of the pressure sensitive layer.

Viewed from another aspect, the present invention provides a method for a load bearing raised flooring system, the method comprising: generating, by a pressure sensitive layer of a load bearing raised flooring system panel, a visual indication at a first surface of the load bearing raised flooring system panel in response to a loading of the load bearing raised flooring system panel exceeding a preset pressure capacity threshold of the pressure sensitive layer.

Viewed from another aspect, the present invention provides a load bearing flooring system including a plurality of load bearing raised flooring system panels.

### DESCRIPTION OF THE DRAWINGS

Embodiment of the present invention will now be described, by way of example only, with reference to accompanying drawings, in which:

FIG. 1 is a perspective view of a raised floor system embodying the present invention;

FIGS. 2A-2B are top down views of the raised floor system of FIG. 1;

FIGS. 3A-3B are perspective views of the layers of the pressure sensitive load bearing raised flooring system panels that may be used for the raised floor system of FIG. 1;

FIGS. 4A-4D are cross sectional views of pressure sensitive load bearing raised flooring system panels that may be used for the raised floor system of FIG. 1;

FIGS. 5A-5D are cross sectional views of the pressure sensitive load bearing raised flooring system panels that may be used for the raised floor system of FIG. 1; and,

FIGS. 6A-6F are top down views of the variations of the pressure sensitive load bearing raised flooring system panels that may be used for the data raised floor system of FIG. 1.

### DETAILED DESCRIPTION

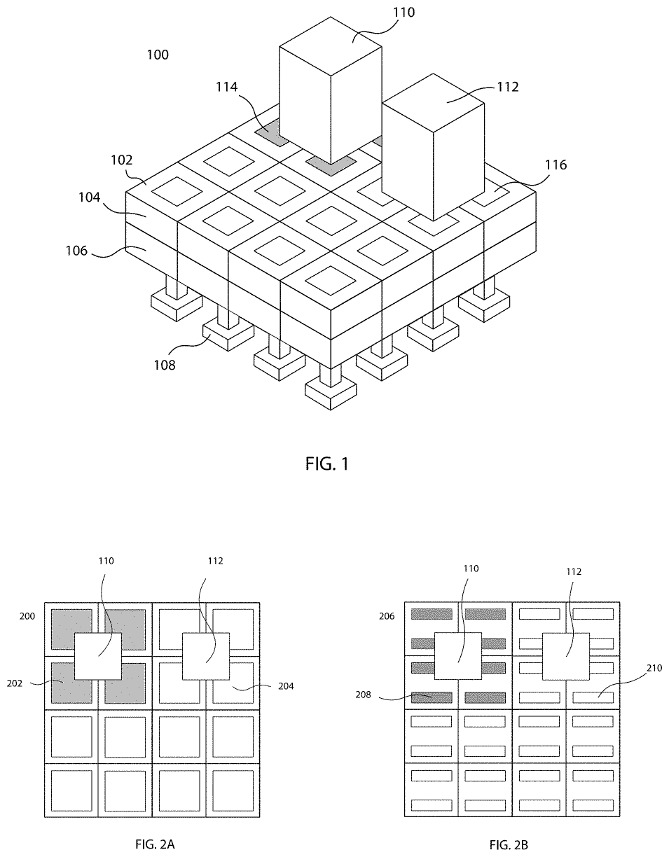

FIG. 1 illustrates a particular embodiment of a raised floor system 100 comprising a raised floor made up of a plurality of load bearing raised flooring system panels 102, the load bearing raised flooring system panels further comprising a first surface 104 and a pressure sensitive layer 106. The pressure sensitive layer comprises a pressure sensitive material which is capable of intrinsically changing its visual characteristics or operable of sending an electrical signal to a visual component which visually indicates the load exceeding a preset pressure capacity threshold. Each of the load bearing raised flooring system panels are supported by a pedestal 108. On the raised floor system are two loads, a first load 110 which exceeds the preset pressure capacity threshold and a second load 112 which does not exceed the preset pressure capacity threshold.

The first load 110 exerts pressure onto the load bearing raised flooring system panels which sit beneath it, and therefore exerts pressure onto the pressure sensitive layer 106. The pressure sensitive material disposed in the pressure sensitive layer responds to the pressure and changes its visual characteristics, which can be seen via a first surface 114. The plurality of load bearing raised floor system panels generate a visual overloading warning when the load exceeds a preset pressure capacity threshold. The load bearing raised flooring system panels which are not supporting loads and load bearing raised flooring system panels that are under the second load do not change their visual characteristics 116.

A first surface 104 protects the other layers of the load bearing raised flooring system panel. A first surface needs to be able to show the visual members of the pressure sensitive layer 106. In one example, the parts of a first surface that are disposed above the pressure sensitive elements of the load bearing raised flooring system panels, such as the pressure sensitive materials and the visual components, may comprise of a clear material such as glass, acrylic plastic or polyvinyl chloride plastic. In another example, all of a first surface can be made of a clear material. In another example, a first surface may house elements of the pressure sensitive layer.

The pressure sensitive layer can be entirely comprised of a pressure sensitive material, or it can house a set of pressure sensitive materials and visual components. In the example where the set of pressure sensitive materials and visual components are encased in the pressure sensitive layer, the pressure sensitive layer can comprise of a material that is capable of providing structural integrity to the encased members.

An embodiment of the pressure sensitive layer comprises a pressure sensitive material which is capable of intrinsically changing its visual characteristics upon excess load pressure. The visual characteristics of the pressure sensitive material shows through a first surface of the load bearing raised flooring system panel.

An example of a pressure sensitive material capable of intrinsically changing its visual characteristics is a pressure sensitive film, which changes color in response to pressure being exerted upon it, such as the Fujifilm Prescale® pressure sensitive film. A pressure sensitive film comprises a layer of micro-encapsulated color forming layer which sits on top of a color-developing layer. When a load exerts pressure on to the color forming layer, exceeding a preset pressure capacity threshold, the micro-encapsulated color forming layer breaks and reacts with the color-developing layer. This results in a color change in the film and the hue of the developed color gets darker as more pressure is applied. The pressure sensitive film visually indicates a load exceeding the preset pressure capacity threshold as well as the magnitude of the exerted pressure upon the load bearing raised flooring system panel.

Another example of a pressure sensitive material capable of intrinsically changing its visual characteristics are strain reactive polymers. These polymers undergo a chemical reaction in response to mechanical stress via a process called polymer mechanochemistry. Researchers at Duke University and MIT have shown polymers in films and gels which change color in response to pressure being applied onto them, as well as being capable of reversing the chemical reaction when the pressure is removed.

Another example of a pressure sensitive material capable of intrinsically changing its visual characteristics are pressure-sensing photonic fibers. Engineers at MIT have demonstrated how the pressure-sensing photonic fibers can change their color depending on the amount of pressure applied to the material.

Another embodiment of the pressure sensitive layer comprises a pressure sensitive material capable of sending an electrical signal to a visual component in response to a pressure exceeding a preset pressure capacity threshold. The visual component changes color or another visual characteristic to represent the magnitude of pressure being exerted upon the load bearing raised flooring system panel.

An example of a pressure sensitive material capable of sending an electrical signal in response to pressure is a piezoelectric material. The piezoelectric material is capable of generating an electric charge in response to pressure via the piezoelectric effect, wherein the positive and negative charges within the material shift, which results in an external electrical field being generated.

Another example of a pressure sensitive material capable of sending an electrical signal in response to pressure is a strain gauge. The strain gauge varies its internal resistance depending on the amount of force applied. The change in resistance can be measured and therefore the amount of pressure being applied to the material can be measured.

The electric signal produced by a pressure sensitive material can be sent to a visual component that is operable for visually indicating the pressure status of the load bearing raised flooring system panel. An example technology suitable for the visualization component is an electronic ink (e-ink) display. E-ink displays require very low power and can retain its content without a power supply. When used as a visual component in the pressure sensitive load bearing raised flooring system panel, the e-ink display can change the whole of display's color or can textually represent the excess load applied onto the load bearing raised flooring system panel.

Another example of a technology suitable for the visual component are Light Emitting Diode (LED) displays. LED displays comprise of light-emitting diodes arranged in arrays. When an LED display is used as the visual component in the pressure sensitive load bearing raised flooring system panel, it can visually change the color of the display or can textually represent the excess load applied onto the load bearing raised flooring system panel.

The pressure sensitive load bearing raised flooring system panel can comprise of additional layers disposed underneath a first surface and the pressure sensitive layer. In one example, a first surface and the pressure sensitive layer can be placed on top of a conventional floor panel. In another example, a first surface and the pressure sensitive layer can be placed on top of additional layers which provide structural integrity or further electrical components to enable additional features such as providing back-lighting for the e-ink display visual component.

FIGS. 2A-2B are top down views of a raised floor system. FIG. 2A illustrates a particular embodiment of the load bearing raised flooring system panel arrangement 200 wherein the pressure sensitive material intrinsically changes its visual characteristics when pressure is exerted upon the material. The visual indication 202 that represents the load exceeding the pressure threshold comes from the pressure sensitive material itself and the visual indication shows via a first surface. The load bearing raised flooring system panels that do not experience a load exceeding the particular pressure threshold do not visually change their color 204.

FIG. 2B illustrates a particular embodiment of the load bearing raised flooring system panel 206 wherein the pressure sensitive material sends an electrical signal to a visual component in response to a pressure exceeding a particular threshold. The visual component changes its visual characteristics 208 when the pressure of the load 110 exceeds the particular pressure threshold via a first surface. The load bearing raised flooring system panels that do not experience a load exceeding the particular pressure threshold do not visually change their color 210.

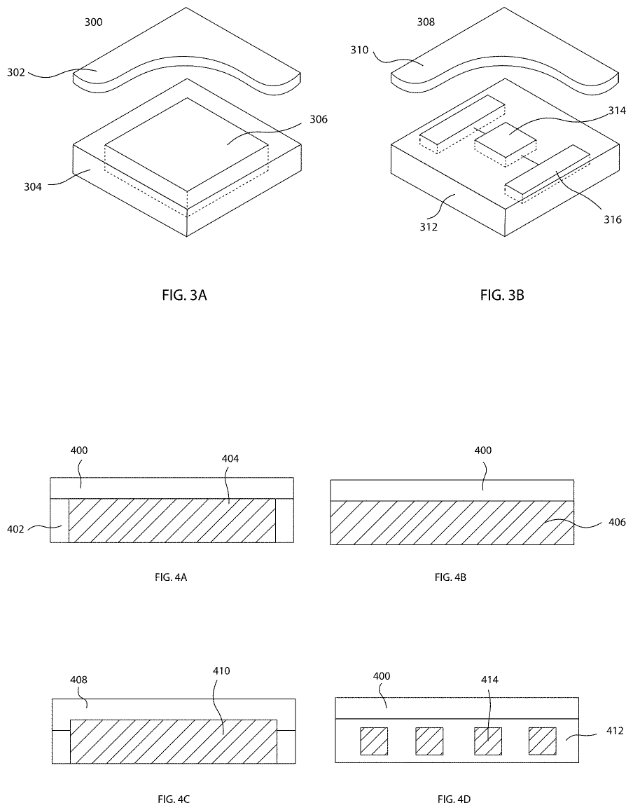

FIG. 3A is a perspective view of a load bearing raised flooring system panel 300 wherein the pressure sensitive material is capable of intrinsically changing its visual characterizes in response to pressure exerted upon the material. A first surface 302 is disposed on top of the pressure sensitive layer 304. The pressure sensitive layer comprises a pressure sensitive material 306.

FIG. 3B is a perspective view of a load bearing raised flooring system panel 308 wherein a first surface 310 is disposed on top of the pressure sensitive layer 312. The pressure sensitive layer 312 further comprises a pressure sensitive material 314 which is capable of sending an electrical signal to a set of visual components 316 in response to a pressure exceeding a preset pressure capacity threshold.

FIG. 4A-4D are cross sectional views of load bearing raised flooring system panels comprising of pressure sensitive materials capable of intrinsically changing its visual characteristics in response to pressure exerted upon the material. FIG. 4A is the load bearing raised flooring system panel illustrated in FIG. 1, FIG. 2A and FIG. 3A. A first surface is disposed above the pressure sensitive layer 402, which comprises a pressure sensitive material 404.

FIG. 4B is a load bearing raised flooring system panel where a first surface 400 is disposed above the pressure sensitive layer, which is entirely comprised of a pressure sensitive material 406. FIG. 4C is a load bearing raised flooring system panel where a first surface 408 encases parts of the pressure sensitive material 410. FIG. 4D is a load bearing raised flooring system panel comprising a first surface 400, disposed above a pressure sensitive layer 412, wherein the pressure sensitive layer further comprises a set of pressure sensitive materials 414 encased within the pressure sensitive layer 412.

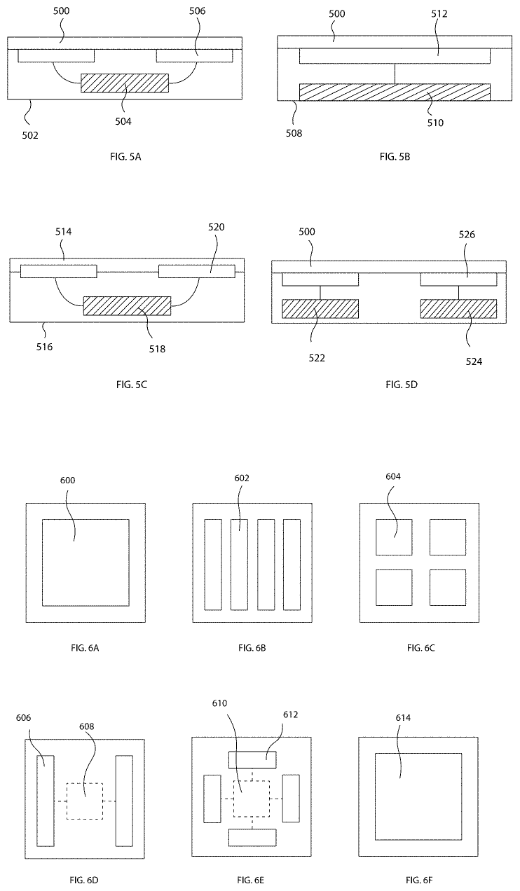

FIGS. 5A-5D are cross-sectional views of load bearing raised flooring system panels comprising of pressure sensitive materials capable of sending an electrical signal to a set of visual components in response to a pressure exceeding a preset pressure capacity threshold. FIG. 5A is a load bearing raised flooring system panel illustrated in FIG. 2B and FIG. 3B. The load bearing raised flooring system panel comprises a first surface 500 disposed above a pressure sensitive layer 502. The pressure sensitive member further comprises a pressure sensitive material 504 connected to two visual components 506.

FIG. 5B is a load bearing raised flooring system panel wherein a first surface 500 is disposed above a pressure sensitive layer 508. The pressure sensitive member further comprises a pressure sensitive material 510 connected to a visual component 512. Both the pressure sensitive material 510 and the visual component 512 are encased within the pressure sensitive layer 508.

FIG. 5C is a load bearing raised flooring system panel wherein a first surface 514 is disposed above a pressure sensitive layer 516. The pressure sensitive material 518 is connected to two visual components 520 which are housed within a first surface.

FIG. 5D is a load bearing raised flooring system panel wherein a first surface 500 disposed above a pressure sensitive layer 522. The pressure sensitive layer further comprises a set of pressure sensitive materials 524, each connected to a visual component 526.

FIG. 6A-6F are top down views of various load bearing raised flooring system panels. FIG. 6A is the load bearing raised flooring system panel illustrated in FIG. 1, FIG. 2A, FIG. 3A and FIG. 4A. A pressure sensitive member 600 is encased within a pressure sensitive layer, such that the visual characteristics of the pressure sensitive member can be seen via a first surface.

FIG. 6B is a load bearing raised flooring system panel illustrated in FIG. 4D. A set of pressure sensitive members 602 are encased within a pressure sensitive layer, such that the visual characteristics of the pressure sensitive member can be seen via a first surface.

FIG. 6C is a load bearing raised flooring system panel wherein a pressure sensitive layer comprises a set of pressure sensitive members 604, such that the visual characteristics of the pressure sensitive member can be seen via a first surface.

FIG. 6D is a load bearing raised flooring system panel illustrated in FIG. 2B, FIG. 3B and FIG. 5A. A pressure sensitive material 608 is connected to a set of visual components 606, such that the visual components can be seen via a first surface.

FIG. 6E is a load bearing raised flooring system panel wherein a pressure sensitive material 612 is connected to a set of visual components 610, such that the visual components can be seen via a first surface.

FIG. 6F is a load bearing raised flooring system panel illustrated in FIG. 5B. The visual component 614 can be seen via a first surface.

Some embodiments of the present invention include at least one flooring tile for a raised floor of a data center, the tile comprising a pair of laminations and a load sensitive material disposed between the laminations, the load bearing material generating a visual indication in response the load on the tile exceeding a predetermined value.

1. A load bearing raised flooring system panel, comprising:
a pressure sensitive layer that generates a visual indication at a first surface of the load bearing raised flooring system panel responsive to a loading of the load bearing raised flooring system panel exceeding a preset pressure capacity threshold of the pressure sensitive layer;
wherein:
the pressure sensitive layer further comprises a layer of pressure sensitive material which intrinsically changes a visual characteristic of the pressure sensitive material responsive to application of pressure upon the pressure sensitive layer through pressure applied upon the first surface.

2. (canceled)

3. The load bearing raised flooring system panel of claim 1, wherein the pressure sensitive layer further comprises at least one visual component operable for displaying the visual indication in response to a change in the pressure sensitive layer.

4. The load bearing raised flooring system panel of claim 3, wherein the pressure sensitive layer further comprises at least one piezoelectric material, which sends an electric signal to the set of visual components responsive to the load exceeding the predetermined value.

5. The load bearing raised flooring system panel of claim 3, wherein the pressure sensitive layer further comprises at least one strain gauge for sending an electric signal to the at least one visual component in response to the load exceeding the predetermined value.

6. The load bearing raised flooring system panel of claim 3, wherein the at least one visual component further comprises of at least one light-emitting diode.

7. The load bearing raised flooring system panel of claim 3, wherein the at least one visual component further comprises an electronic-ink display.

8. A method for generating a visual overloading warning in a load bearing raised flooring system, the method comprising:
generating, by a pressure sensitive layer of a load bearing raised flooring system panel, a visual indication at a first surface of the load bearing raised flooring system panel responsive to a loading of the load bearing raised flooring system panel exceeding a preset pressure capacity threshold of the pressure sensitive layer;
wherein:
the pressure sensitive layer further comprises a layer of pressure sensitive material which intrinsically changes a visual characteristic of the pressure sensitive material responsive to application of pressure upon the pressure sensitive layer through pressure applied upon the first surface.

9. The method of claim 8, further comprising:
changing a visual characteristic of the visual indication, by the pressure sensitive layer, responsive to the load exceeding the predetermined value.

10. The method of claim 8, further comprising:
displaying the visual indication, by at least one visual component, responsive to the load exceeding the predetermined value.

11. The method of claim 10, further comprising:
sending an electric signal, by at least one piezoelectric material, to the set of visual components responsive to the load exceeding the predetermined value.

12. The method of claim 10, further comprising:
sending an electrical signal, by at least one strain gauge, to the set of visual components responsive to the load exceeding the predetermined value.

13. The method of claim 10, wherein the at least one visual component comprises of at least one light-emitting diode.

14. The method of claim 10, wherein the at least one visual component comprises an electronic-ink display.

15. A load bearing flooring system, the system comprising:
a plurality of load bearing raised flooring system panels, where a given load bearing raised flooring system panel includes a pressure sensitive layer that generates a visual indication at a first surface of the load bearing raised flooring system panel responsive to a loading of the load bearing raised flooring system panel exceeding a preset pressure capacity threshold of the pressure sensitive layer, and the given load bearing raised flooring system panel is connected to at least one other load bearing raised flooring system panel;
wherein:
the pressure sensitive layer further comprises a layer of pressure sensitive material which intrinsically changes a visual characteristic of the pressure sensitive material responsive to application of pressure upon the pressure sensitive layer through pressure applied upon the first surface.

16. (canceled)

17. The system of claim 15, wherein the pressure sensitive layer further comprises at least one visual component operable for displaying the visual indication in response to a change in the pressure sensitive layer.

18. The system of claim 17, wherein the pressure sensitive layer further comprises at least one piezoelectric material, which sends an electric signal to the set of visual components responsive to the load exceeding the predetermined value.

19. The system of claim 17, wherein the pressure sensitive layer further comprises at least one strain gauge for sending an electric signal to the at least one visual component in response to the load exceeding the predetermined value.

20. The system of claim 17, wherein the at least one visual component further comprises of at least one light-emitting diode.
